(19) United States
(12) Patent Application Publication
(10) Pub. No.: US 2024/0207876 A1
(43) Pub. Date: Jun. 27, 2024

(54) Handheld gardening Sprayer

(71) Applicant: TING-CHENG HUANG, Lukang Township (TW)

(72) Inventor: TING-CHENG HUANG, Lukang Township (TW)

(21) Appl. No.: 18/086,512

(22) Filed: Dec. 21, 2022

(51) Int. Cl. B05B 9/01; B05B 1/16

(52) U.S. Cl. CPC B05B 9/01; B05B 1/169

(57) ABSTRACT

A handheld gardening sprayer includes: a spraying gun, a spraying head and a rotating ring. The spraying gun has a main body, the main body has an intake end and an output end, and the spraying has an engaging hole at center and a plurality of the water spouts of different shapes around the engaging hole. The outer periphery of the rotating ring is provided with at least one ring groove, and the outer surface of the ring groove is connected with several the water channels in a branch shape, the spraying head.

### BACKGROUND OF INVENTION

### Field of Invention

The present invention relates to a handheld gardening sprayer, and more particularly to a handheld gardening sprayer with an adjusting valve.

### Description of the Related Art

In order to avoid plants drying up and dying due to lack of water, watering routine is a very frequent and important gardening work. Usually the plants are planted in a wide range or a certain distance from the water source, therefore, the water hose extension is employed and connected to the water via a connector, then the water hose is connected to the spraying gun to cover large area. It is very common that the spraying gun has a spraying head on the top, and the spraying head can be used to change the shape of the water spray when the spraying gun being held and rotated.

However, because the surface of the spraying head of the conventional spraying gun does not have a good drainage ability, it is often caused accumulated water in its surface or wet hands. Afterward, the spraying head has the problem of being hard to hold and turn, which is quite inconvenient to use.

Therefore, it is desirable to provide a handheld gardening sprayer to mitigate and/or obviate the aforementioned problems.

### SUMMARY OF THE INVENTION

An objective of present invention is to provide a handheld gardening sprayer which is capable of improving the above-mention problems.

In order to achieve the above mentioned objective, a handheld gardening sprayer has: a spraying gun, a spraying head and a rotating ring. The spraying gun has a main body, the main body has an intake end and an output end, and the spraying has an engaging hole at center and a plurality of the water spouts of different shapes around the engaging hole. The outer periphery of the rotating ring is provided with at least one ring groove, and the outer surface of the ring groove is connected with several the water channels in a branch shape, the spraying head.

Other objects, advantages, and novel features of invention will become more apparent from the following detailed description when taken in conjunction with the accompanying drawings.

### BRIEF DESCRIPTION OF DRAWINGS

FIG. 1 is a three-dimensional combined view of a preferred embodiment according to the present invention.

FIG. 2 is a three-dimensional exploded view of the preferred embodiment according to the present invention.

FIG. 3 is a schematic drawing of the preferred embodiment according to the present invention.

FIG. 4 is a cross-sectional view of the preferred embodiment according to the present invention.

FIG. 5 is a state drawing showing rapid drainage of water according to the present invention.

FIG. 6 is state drawing showing an enlarged contact area according to the present invention.

FIG. 7 is a partial enlarged view of the increased contact area according to the present invention.

### DETAILED DESCRIPTION OF THE PREFERRED EMBODIMENT

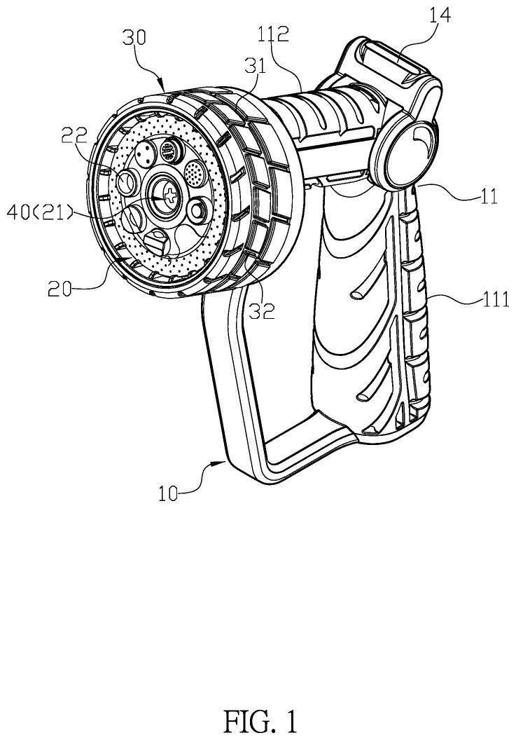

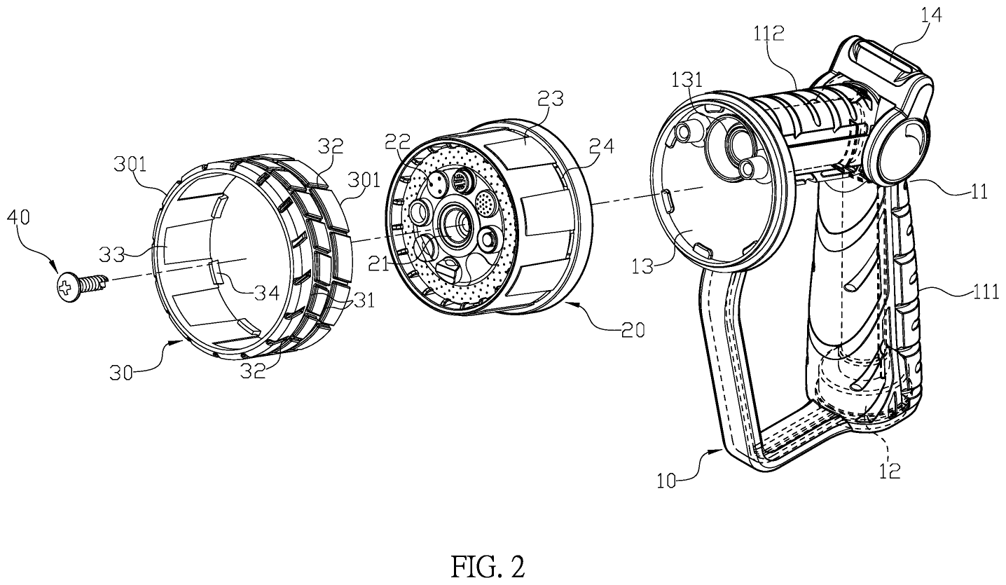

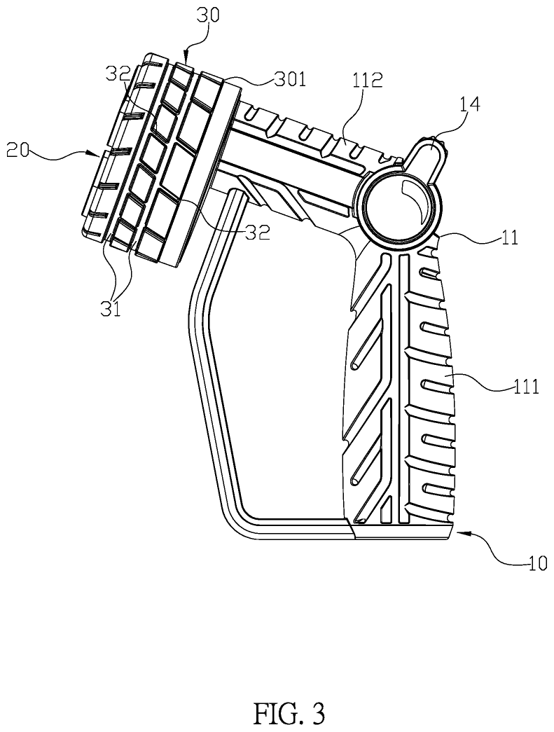

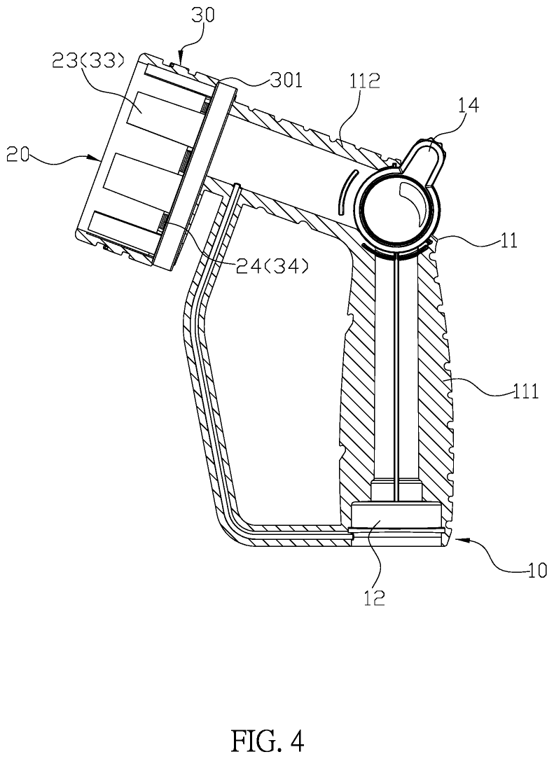

First, please refer to FIG. 1-FIG. 4. A handheld gardening sprayer comprises: a spraying gun 10, a spraying head 20 and a rotating ring 30. The spraying gun 10 has a main body 11 with an intake end 12 connectable to a water source and an output end 13 configured for connection to the spraying head 20 and further having an outlet conduit 131. Therefore, water is capable of flowing into the spraying gun 10 from the intake end 12, through the main body 11 to enter the outlet conduit 131 and exit from the spraying head 20. Furthermore, the spraying head 20 has an engaging hole 21 accepting a shaft 40 and the shaft is coupled to the output end 13 of the spraying gun 10. The spraying head 20 further comprises a plurality of water spouts 22 with different shapes around the engaging hole 21; wherein when the spraying head 20 is rotated, the outlet conduit 131 is capable of being connected to different water spouts 22. The rotating ring 30 is sleeved onto the spraying head 20 and the spraying head 20 is capable of being rotated by the rotating ring 30; and the rotating ring 30 has at least one ring groove 31, the ring groove 31 is connected to a plurality of water channels 32 for drainage. The connection between the ring groove 31 and the water channel 32 are designed to quickly drain the water attached to the rotating ring 30, but also provide increased contact area, so that the rotating ring 30 together with the spraying head 20 can be held and rotated more easily.

Moreover, the main body 11 comprises a handle portion 111 and a chamber portion 112 internally connected, the intake end 12 and the output end 13 are respectively assembled at a rear end of the handle portion 111 and a front end of the chamber portion 112, and the outlet conduit 131 is disposed in the chamber portion 112.

In addition, the main body 10 of the spraying gun further has a water valve switch 14 for controlling water flow.

Also, the spraying head 20 further has a positioning stub 23 and a buttonhole 24 at a surface, and the rotating ring 30 further has a positioning groove 33 configured to engage with the positioning stub 23 and a claw 34 configured to hook with the buttonhole 24.

Additionally, the water channel 32 is connected via an incline to the ring groove 31.

Furthermore, the rotating ring 30 has two end faces 301, and the water channel 32 passes through at least one of the end faces 301 of the rotating ring 30.

Moreover, the shaft 40 is a screw configured to lock the spraying head 20.

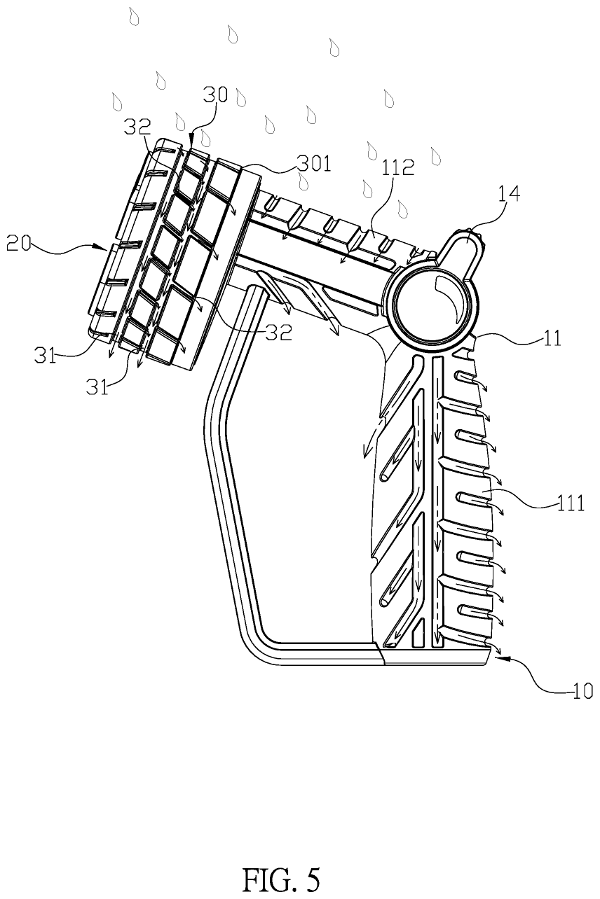

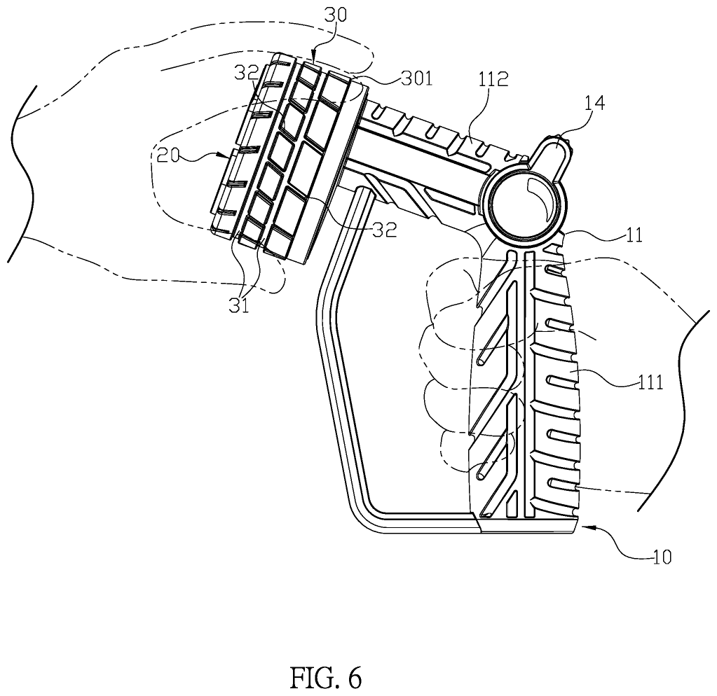

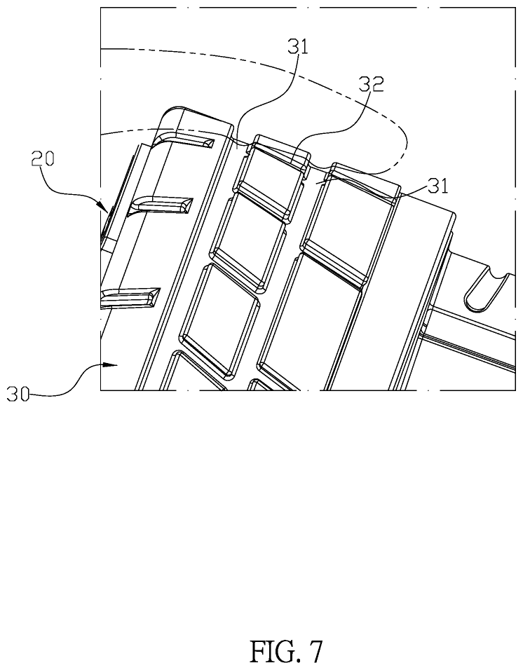

In actual application, water on the rotating ring 30 is guided to the ring groove 31 through the water channel 32, so that the water passes through the ring groove 31 and drains down quickly, as shown in FIG. 5. Furthermore, with the concave design of the ring groove 31 and the water channel 32, the contact area is also effectively increased, as shown in FIG. 6 and FIG. 7. Therefore, even if the spraying gun 10 is wet or the user has wet hands, the rotating ring 30 and the spraying head 20 can still be held and rotated, which is easier and more accurate to control.

Although the present invention has been explained in relation to its preferred embodiment, it is to be understood that many other possible modifications and variations can be made without departing from the spirit and scope of invention as hereinafter claimed.

What is claimed is:

1. A handheld gardening sprayer comprising: a spraying gun, a spraying head and a rotating ring; wherein the spraying gun has a main body with an intake end connectable to a water source and an output end configured for connection to the spraying head and further having an outlet conduit; wherein water is capable of flowing into the spraying gun from the intake end, through the main body to enter the outlet conduit and exit from the spraying head; the spraying head has an engaging hole accepting a shaft and the shaft is coupled to the output end of the spraying gun; the spraying head further comprises a plurality of water spouts with different shapes around the engaging hole; wherein when the spraying head is rotated, the outlet conduit is capable of being connected to different water spouts; characterized in that:
the rotating ring is sleeved onto the spraying head and the spraying head is capable of being rotated by the rotating ring; and the rotating ring has at least one ring groove, the ring groove connected to a plurality of water channels for drainage.

2. The handheld gardening sprayer as claimed in claim 1, wherein the main body comprises a handle portion and a chamber portion internally connected, the intake end and the output end are respectively assembled at a rear end of the handle portion and a front end of the chamber portion, and the outlet conduit is disposed in the chamber portion.

3. The handheld gardening sprayer as claimed in claim 1, wherein the main body of the spraying gun further has a water valve switch for controlling water flow.

4. The handheld gardening sprayer as claimed in claim 1, wherein the spraying head further has a positioning stub and a buttonhole at a surface, and the rotating ring further has a positioning groove configured to engage with the positioning stub and a claw configured to hook with the buttonhole.

5. The handheld gardening sprayer as claimed in claim 1, wherein the water channel is connected via an incline to the ring groove.

6. The handheld gardening sprayer as claimed in claim 1, wherein the rotating ring has two end faces, and the water channel passes through at least one of the end faces of the rotating ring.
